(19) United States
(12) Patent Application Publication
(10) Pub. No.: US 2011/0198902 A1
(43) Pub. Date: Aug. 18, 2011

(54) COLLAPSIBLE MASSAGE STOOL SYSTEMS

(76) Inventors: Phillip Renbarger, Marion, IN (US); Renee Renbarger, Marion, IN (US)

(21) Appl. No.: 12/853,089

(22) Filed: Aug. 9, 2010

Related U.S. Application Data
(60) Provisional application No. 61/304,546, filed on Feb. 15, 2010.

(51) Int. Cl. A47C 31/00; A47C 4/00; G09F 3/00; A47C 1/022; B62B 1/12; B23P 17/04

(52) U.S. Cl. 297/219.1; 297/452.1; 40/320; 297/311; 280/38; 29/401.1

(57) ABSTRACT

A collapsible massage stool, durable and sturdy in use is disclosed which that may be efficiently stored during non-use periods in a folded position. The device may be fitted with a removable cover sporting indicia. A kit and method of use are also described herein.

### CROSS-REFERENCE TO RELATED APPLICATION

The present application is related to and claims priority from prior provisional application Ser. No. 61/304,546, filed Feb. 15, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of stools and more specifically relates to collapsible massage stools.

2. Description of the Related Art

Chairs provide a raised surface traditionally used to sit on, commonly for use by one person. Chairs often have the seat raised above floor level, and may be supported by up to four legs. Chairs come in many shapes and sizes and may provide various functional uses. Chair without a back or arm rests is referred to as a stool. Stools are often stacked to provide efficiency in storage, however may not be easily portable based on their traditional construction. A need exists for an improved collapsible version of a stool.

Massage may involve the manipulation of superficial layers of muscle and connective tissue to enhance the function and promote relaxation and well-being. Massage may involve manipulating the body with strategic pressure via structured, unstructured, stationary, or moving, tension, motion, or vibration, done manually or with the use of mechanical aids. Target tissues may include muscles, tendons, ligaments, skin, joints, or other connective tissue, as well as lymphatic vessels, or organs of the gastrointestinal system. Massage can be applied with the hands, fingers, elbows, knees, forearm, and feet. These manipulations may be performed by a masseuse to an individual that is supported on a raised massage table, a bed or other suitable raised surface to provide comfort for the individual being treated and to the masseuse. These tables may be expensive and inconvenient to store.

For those with arthritis or back and neck injuries, a massage can offer substantial relief. However, paying for massages can become costly. Some individuals ask a family member or friend to perform a massage. Many are positioned in a way that makes it difficult to get close to the subject and apply adequate pressure to the muscles. It is also uncomfortable to straddle the individual and rest on one's knees, especially if that individual has had knee replacement or surgery. The person giving the massage may sit on the individual's back, but this often puts unnecessary pressure on a back that is already tender. A more efficient method is needed.

Various attempts have been made to solve the above-mentioned problems such as those found in U.S. Pat. Nos. 5,054,144, 1,520,589, 3,940,181, 4,561,692, 130,494, and 5,876,098. This prior art is representative of stools. None of the above inventions and patents, taken either singly or in combination, is seen to describe the invention as claimed.

Ideally, a massage stool should require minimal storage space, be sufficiently sturdy, comfortable to sit on, operate reliably and be manufactured at a modest expense. Thus, a need exists for a reliable collapsible massage stool system to avoid the above-mentioned problems.

### BRIEF SUMMARY OF THE INVENTION

In view of the foregoing disadvantages inherent in the known stool art, the present invention provides a novel collapsible massage stool system. The general purpose of the present invention, which will be described subsequently in greater detail is to provide a collapsible massage stool, durable and sturdy in use and that may be efficiently stored during non-use periods.

A collapsible massage stool is disclosed herein comprising: a plurality of removable height and width adjustable L-shaped legs (preferably four) wherein the four L-shaped legs are upwardly rotatable within housing tubes located under a seat into a locked or unlocked position. The present invention also comprises support arm(s); locking wheels; at least one hinging means; at least one push button providing locking and unlocking means; at least one removable cover optionally comprising indicia; a seat; at least one housing tube; wherein the four L-shaped legs are rotatably engaged downwardly within the housing tubes of the seat via the hinging means and locked via a push button mechanism to support the collapsible massage stool at a height above a planar surface. The device thereby providing a sitting-surface in-use position for a masseuse to be supported comfortably straddling a patient to provide a massage to the patient. The collapsible massage stool may be rotated/folded (when unlocked via the push button) and into a storage position via the hinging means for a non-use period. Locking wheels are optionally received by the L-shaped legs creating a means for lateral rolling movement of the collapsible massage stool. The seat may be covered via the removable cover which may comprise indicia such as advertisements, logos of favorite teams, school institutions, characters or other.

A kit is also disclosed herein including: a plurality of L-shaped legs; a seat; a seat cover (optionally having user-preferred indicia); at least one housing tube; and a set of user instructions. Optionally the kit may include lockable wheels for use preferably with front (or alternately rear or front and rear) legs. Wheels may be sold separately. The kit is preferably manufactured and shipped in an unassembled condition for cost-effectiveness and ease of transport/storage.

Lastly, a method of using a collapsible massage stool is discussed comprising the steps of: rotating the L-shaped legs into a substantially perpendicular relationship with the seat of the collapsible massage stool before straddling a patient with the collapsible massage stool; and the masseuse comfortably massaging the patient. When the massage procedure is completed the method may further comprise the step of rotating the L-shaped legs into a parallel relationship with the seat of the collapsible massage stool (a folded position) for efficient and convenient storage. The method may also optionally include removing the L-shaped legs and storing the collapsible massage stool during a non-use period in an un-assembled condition.

The present invention holds significant improvements and serves as a collapsible massage stool system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, collapsible massage stool, constructed and operative according to the teachings of the present invention.

FIG. 1 shows a perspective view illustrating a collapsible massage stool as placed over an individual receiving a massage according to an embodiment of the present invention.

FIG. 2 is a perspective view illustrating the collapsible massage stool as adjustable to a range of heights and widths according to an embodiment of the present invention of FIG. 1.

FIG. 3 is a perspective view illustrating the collapsible massage stool in a folded position according to an embodiment of the present invention of FIGS. 1 and 2.

FIG. 4 is a perspective view the collapsible massage stool in a disassembled condition according to an embodiment of the present invention of FIG. 1.

FIG. 5 shows a flowchart illustrating a method of use for the collapsible massage stool according to an embodiment of the present invention of FIGS. 1-4.

The various embodiments of the present invention will hereinafter be described in conjunction with the appended drawings, wherein like designations denote like elements.

### DETAILED DESCRIPTION

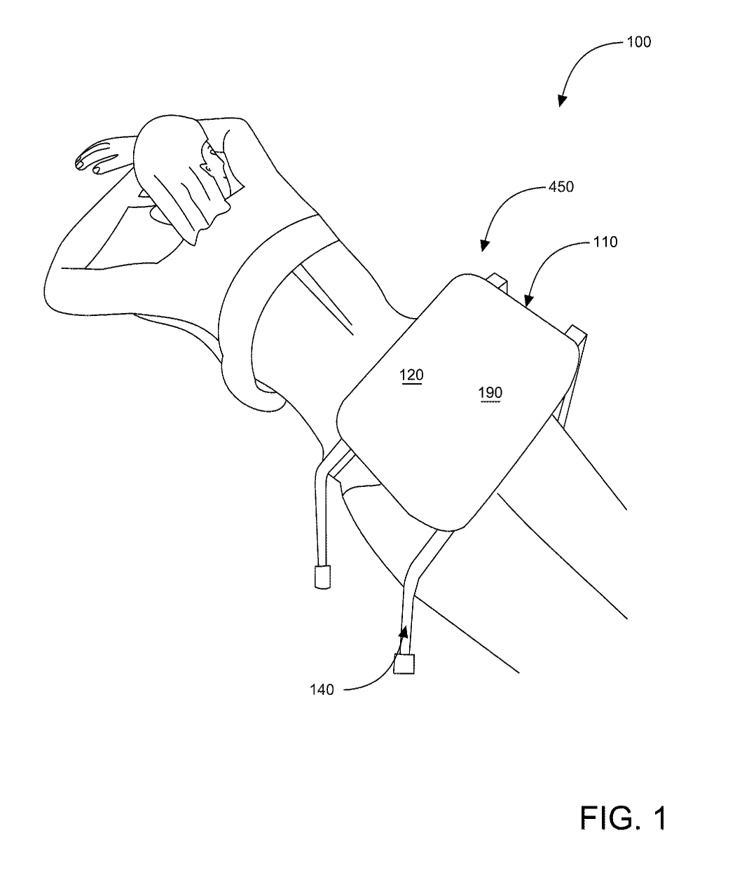

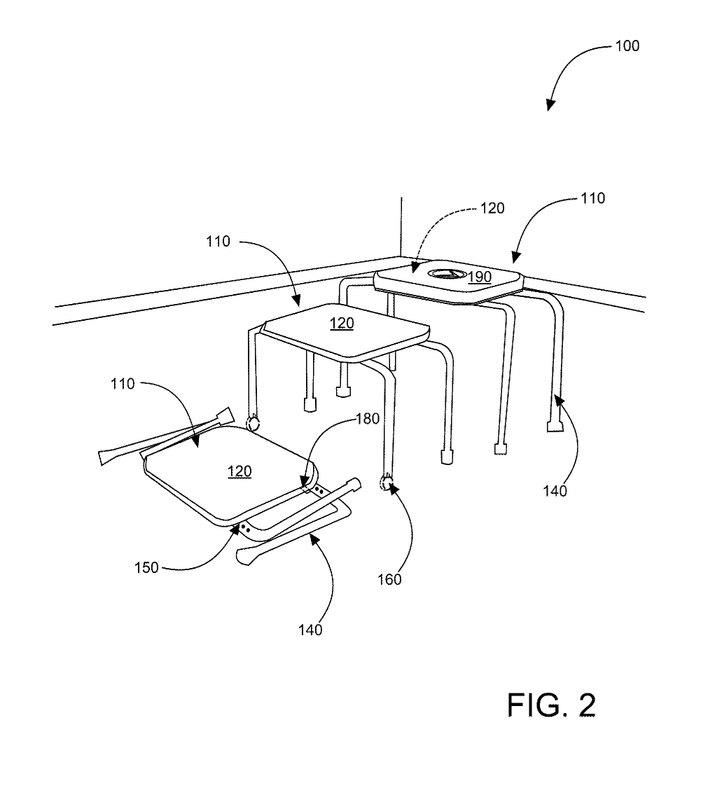

As discussed above, embodiments of the present invention relate to a massage stool device and more particularly to a collapsible massage stool 110 of the collapsible massage stool system 100 as used to improve the comfort of a masseuse and a massage patient. Referring generally to the included FIGS. 1-4, collapsible massage stool 110 within the present invention is designed to provide individuals with an efficient method for executing massages in the home (and/or office). Collapsible massage stool 110 allows an individual to sit closely to the individual receiving the massage so that they are able to give a more effective deep tissue massage. Collapsible massage stool 110 can provide a comfortable and convenient place to sit for those that are performing the massage. The stool is preferably collapsible (as shown in FIGS. 2-4) and height and/or width adjustable, as shown in FIG. 2 making it easy to store. Collapsible massage stool 110 provides consumers with comfort and efficiency during a back and neck massage.

Collapsible massage stool 110 offers consumers an effective means for comfortably performing/receiving at least one massage. Collapsible massage stool 110 may be placed over a person's back, hips or other (straddling the patient) while the individual is lying on the floor, as shown in FIG. 1. Another individual can sit comfortably on collapsible massage stool 110, at a position over top of the person in order to give them a massage. Collapsible massage stool 110 may have at least one seat 120 optionally with cushioning means thereby providing comfort in use. Housing tube(s) 130 may be located under seat 120. Housing tube(s) 130 enable L-shaped legs 140 to be adjusted in size using at least one push button 150. L-shaped legs 140 may be adjusted in both height and width directions to accommodate individuals of various sizes, as alluded to in FIG. 2. The L-shaped legs 140 when arranged in the front preferably extend out the side of seat 120 and may angle slightly forward for increased stability in use. This feature also helps support the weight of the masseuse on collapsible massage stool 110 as they lean forward (and backward). L-shaped legs 140 (front arranged L-shaped legs 140 particularly) may also comprise at least one locking wheel 160, which will substantially prevent collapsible massage stool 110 from sliding while in use, if locking wheels 160 are in a locked condition.

The back oriented L-shaped legs 140 may optionally include at least one support arm. In certain embodiments collapsible massage stool 110 may comprise a removable back portion to support the user while sitting. The embodiment shown doesn't comprise a back portion. Support arm may comprise sufficiently durable hollow, tubular material, which will allow push buttons 150 inside to slide until they lock into place and yet still remain accessible. Each of L-shaped legs 140 may also have at least one folding hinge 180 so that L-shaped legs 140 can be folded underneath seat 120 for easy storage. Seat 120 may measure approximately 12 inches by about 10 inches and the sitting surface may be substantially planar. L-shaped legs 140 may extend from about 9 inches to about 14 inches in height, as alluded to in FIGS. 1 and 2.

Referring to the drawings by numerals of reference there is shown in FIG. 1, collapsible massage stool 110 of collapsible massage stool system 100 may be placed over an individual receiving a massage according to an embodiment of the present invention.

Collapsible massage stool 110 within the present invention preferably comprises: a plurality of L-shaped legs 140 (preferably four); seat 120; at least one housing tube 130; wherein four of L-shaped legs 140 are rotatably engaged downwardly within housing tubes 130 of seat 120 and locked to support collapsible massage stool 110 at a height above a planar surface such as the floor, ground or other substrate/horizontal surface thereby providing a sitting-surface in-use position for a masseuse to be supported straddling a patient such that they may comfortably provide a massage to the patient.

In certain embodiments collapsible massage stool 110 further comprising at least one removable cover 190 which may or may not comprise indicia. Indicia may comprise advertisements, logos of favorite teams, schooling institutions, characters, or other. Upon reading this specification, it should be appreciated that, under appropriate circumstances, considering such issues as user preferences, design preference, structural requirements, marketing preferences, cost, available materials, technological advances, etc., other indicia means and arrangements such as, for example, names, designs, pictures, etc., may be sufficient. FIG. 1 is used to exemplify how the present invention may be used to comfortably and safely straddle an individual receiving a massage from another.

Referring now to FIG. 2, a perspective view illustrating collapsible massage stool 110 which is adjustable to a range of heights and widths according to an embodiment of the present invention of FIG. 1.

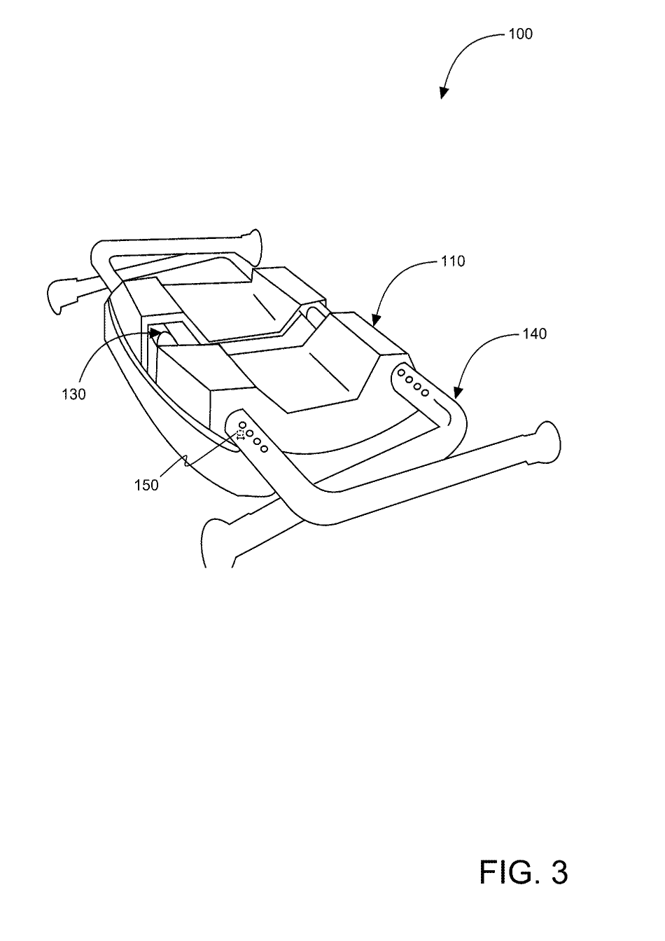

As previously disclosed, collapsible massage stool 110 preferably comprises four L-shaped legs 140 which are upwardly rotatable within housing tubes 130 of seat 120 into an unlocked position to form an efficient and effective stored position. Further, as discussed previously L-shaped legs 140 may be width adjusted within housing tubes 130 inwardly and outwardly and locked in the desire position via push buttons 150. L-shaped legs 140 of collapsible massage stool 110 may also be height adjustable. In this way collapsible massage stool 110 may efficiently and effectively accommodate users of different body statures and sizes. Collapsible massage stool 110 is also shown in the folded/stored position as also embodied in FIG. 3.

Referring now to FIG. 3, showing a perspective view illustrating collapsible massage stool 110 in a folded position according to an embodiment of the present invention of FIGS. 1 and 2.

L-shaped legs 140 of collapsible massage stool 110 may comprise plastic or rubberized caps within the embodiment shown for even weight distribution and/or L-shaped legs 140 may comprise locking wheels 160 (illustrated in dotted lines). Locking wheels 160 may provide means whereby the present invention may be moved transversely across a surface such as the floor or other, and when locked be substantially prevented from such movement. This feature may provide increased speed and efficiency in use. Further, the locking means may increase safety in-use. Collapsible massage stool 110 is shown in a folded position to illustrate its improved ability to be stored in a smaller space than conventional chairs and/or stools. In this way the present invention is conveniently storable.

In a preferred embodiment of collapsible massage stool 110, seat 120 is angled such that it is comfortable and stable in-use for the user. The inventor has found that a tilt of ½′-1″ angled downwardly from back to front serves this purpose well. It should be appreciated that these measurements are exemplary and may be altered and still be considered to be within the scope of this disclosure. Further, other tilting and arranging means may be used in collapsible massage stool 110 and in certain embodiments collapsible massage stool 110 may serve as a ‘multi-purpose chair’ for tasks other than massaging. For example L-shaped legs 140 located in front may be adjustable or manufactured to a greater length to provide a substantially flat surface for seat 120.

Collapsible massage stool 110 may further comprise a hinging member (at least hereby embodying folding hinge 180) to provide suitable rotation means for L-shaped legs 140 about at least one axis. Further, L-shaped legs 140 may comprise at least one support arm. As disclosed previously collapsible massage stool 110 has L-shaped legs 140 which are height-adjustable. Further, using the rotation features of the present invention, collapsible massage stool 110 may extend from about 9 inches to about 14 inches in height, as alluded to in FIGS. 1 and 2 to about 3 inches for storage because L-shaped legs 140 may be folded underneath seat 120 for storage. In this position, L-shaped legs 140 of collapsible massage stool 110 are folded such that L-shaped legs 140 are substantially parallel with seat 120.

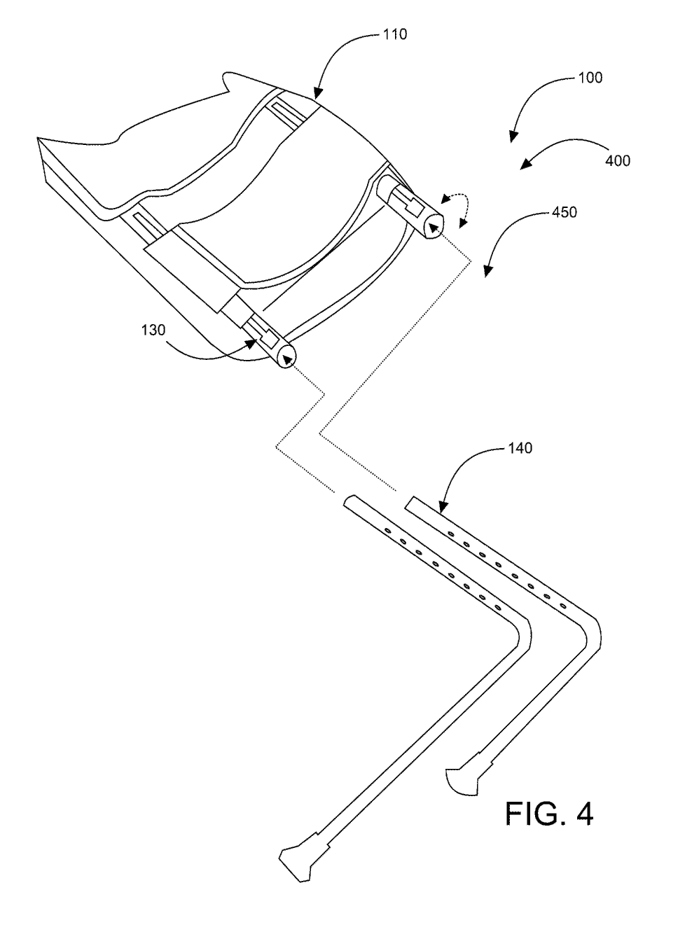

Referring now to FIG. 4, a perspective view of collapsible massage stool 110 in a disassembled condition 400 according to an embodiment of the present invention of FIG. 1.

Collapsible massage stool 110 may be disassembled such that L-shaped legs 140 are removable thereby creating disassembled condition 400, as illustrated. This feature also provides another efficient means for storing, transporting the present invention. Collapsible massage stool 110 may comprise a kit 450 including: a plurality of L-shaped legs 140; at least one seat 120; at least one user-preferred removable cover 190 having indicia (removable cover 190 may also comprise sweat absorption means and other); at least one housing tube 130; and a set of user instructions (not shown). Kit 450 may also comprise locking wheel(s) 160 (or they may be sold separately). In this way collapsible massage stool system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately such as wheels, etc., may be sufficient.

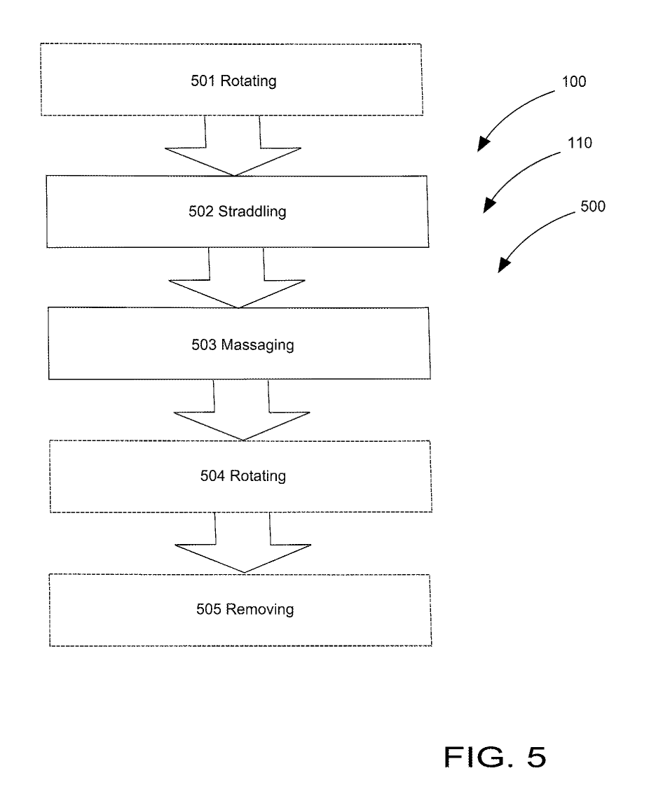

Referring now to FIG. 5, is a flowchart illustrating a method of use for collapsible massage stool 110 according to an embodiment of the present invention of FIGS. 1-4.

A method 500 of using a collapsible massage stool 110 comprising the steps of: optional step one 501 rotating L-shaped legs 140 into a perpendicular relationship with seat 120 of collapsible massage stool 110 before step two 502 straddling a patient with collapsible massage stool 110; and step three 503 massaging the patient while sitting on collapsible massage stool 110. Method 500 of using a collapsible massage stool 110 may further comprising the step four 504 of rotating L-shaped legs 140 into a parallel relationship with seat 120 of collapsible massage stool 110 after straddling the patient with collapsible massage stool 110 for storage. Optionally, method 500 of using collapsible massage stool 110 may further comprise the step five 505 of removing L-shaped legs 140 and storing collapsible massage stool 110 during a non-use period.

It should be noted that steps 501, 504 and 505 are optional steps and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A collapsible massage stool comprising:
four L-shaped legs;
a seat;
at least one housing tube;
wherein said four L-shaped legs are rotatably engaged downwardly within said housing tubes of said seat and locked to support said collapsible massage stool at a height above a planar surface thereby providing a sitting-surface in use position for a masseuse to be supported stradling a patient to provide a massage to said patient.

2. The collapsible massage stool of claim 1 wherein said four L-shaped legs are upwardly rotatable within said housing tubes of said seat into an unlocked position.

3. The collapsible massage stool of claim 1 wherein said unlocked position comprises a stored position.

4. The collapsible massage stool of claim 1 further comprising at least one removable cover.

5. The collapsible massage stool of claim 4 wherein said at least one removable cover comprises indicia.

6. The collapsible massage stool of claim 1 wherein said L-shaped legs further comprise locking wheels.

7. The collapsible massage stool of claim 1 wherein said collapsible massage stool further comprises a hinging member.

8. The collapsible massage stool of claim 1 wherein said L-shaped legs further comprise at least one support arm.

9. The collapsible massage stool of claim 1 wherein said L-shaped legs are height-adjustable.

10. The collapsible massage stool of claim 1 wherein said L-shaped legs are width-adjustable.

11. The collapsible massage stool of claim 1 wherein said L-shaped legs can be folded underneath said seat for storage.

12. The collapsible massage stool of claim 1 further comprising at least one push button.

13. The collapsible massage stool of claim 1 wherein said L-shaped legs are removable.

14. The collapsible massage stool of claim 11 wherein said L-shaped legs are folded such that said legs are parallel with said seat.

15. A collapsible massage stool comprising:
four removable height and width adjustable L-shaped legs wherein said four L-shaped legs are upwardly rotatable within housing tubes located under a seat into a locked or unlocked position;
support arm(s);
locking wheels;
at least one hinging means;
at least one push button providing locking and unlocking means;
at least one removable cover comprising indicia;
a seat;
at least one housing tube;
wherein said four L-shaped legs are rotatably engaged downwardly within said housing tubes of said seat via said hinging means and locked via said push button to support said collapsible massage stool at a height above a planar surface thereby providing a sitting-surface in use position for a masseuse to be supported straddling a patient to provide a massage to said patient or unlocked via said push button and rotated into a storage position via said hinging means for a non-use period;
wherein said locking wheels are received by said L-shaped legs creating a means for lateral rolling movement; and
wherein said seat is covered via said removable cover comprising indicia.

16. The collapsible massage stool of claim 15 further comprises a kit including:
a plurality of said L-shaped legs;
said seat;
said seat cover having indicia;
at least one housing tube; and
a set of user instructions.

17. A method of using a collapsible massage stool comprising the steps of:
straddling a patient with said collapsible massage stool; and
massaging said patient.

18. The method of using a collapsible massage stool of claim 17 further comprising the step of:
rotating L-shaped legs into a perpendicular relationship with a seat of said collapsible massage stool before straddling said patient with said collapsible massage stool.

19. The method of using a collapsible massage stool of claim 18 further comprising the step of:
rotating L-shaped legs into a parallel relationship with said seat of said collapsible massage stool after straddling said patient with said collapsible massage stool for storage.

20. The method of using a collapsible massage stool of claim 18 further comprising the step of:
removing said L-shaped legs and storing said collapsible massage stool during a non-use period.
